(19) United States
(12) Patent Application Publication
(10) Pub. No.: US 2009/0324374 A1
(43) Pub. Date: Dec. 31, 2009

(54) LOADING AND UNLOADING DEVICE

(76) Inventor: Jean-Claude De Carli, Chateauneuf De Grasse (FR)

Correspondence Address: YOUNG & THOMPSON, 209 Madison Street, Suite 500, Alexandria, VA, 22314, US

(21) Appl. No.: 12/374,885

(22) PCT Filed: Jul. 19, 2007
(86) PCT No.: PCT/EP2007/057460

§ 371 Date: Jan. 23, 2009

(30) Foreign Application Priority Data
Jul. 28, 2006 (FR) 0653164

(51) Int. Cl. B60P 1/16

(52) U.S. Cl. 414/478

(57) ABSTRACT

A loading and unloading device for carrier vehicle includes: a container provided with a gripping element in its lower part; a dummy underframe mounted on the carrier vehicle; a pivoting chassis pivotably mounted on the dummy underframe, a trolley sliding on the pivoting chassis, suitable for driving the container on the pivoting chassis by a drive element for cooperating with the gripping element of the container. The device includes an arm mounted rotatably at the end of the dummy underframe, the arm provided with a hooking element suitable for cooperating with the gripping element located at the lower part of the container, the arm is suitable for conveying the container from a position appreciably on the ground to a position appreciably at the level of the pivoting chassis or vice versa. The device applies in particular to the loading and unloading of dumpsters, box beams or any materials on cradles.

This invention concerns a loading and unloading device for any carrier vehicle and trailer.

Its application will be found in particular in loading and unloading all types of open or closed containers such as tipper trucks or vessels in all road haulage, agricultural, forestry, and other fields.

The term container extends in the widest sense to any equipment or object equipped with or fitted on cradles.

US document U.S. Pat. No. 3,638,817 describes a device for loading containers on trailers by a cable fixed to the lower part of said container.

The device has the disadvantage of requiring the operator to fix the cable on the container.

The present invention tends to solve this problem by proposing a loading and unloading device for use on vehicles comprising:
a container provided in its lower part with gripping means,
a dummy underframe on the vehicle,
a pivoting chassis fitted to tilt on said dummy underframe,
a trolley sliding on said pivoting chassis, able to bring said container onto said pivoting chassis through the action of drive means able to act with said gripping means of the said container,
   characterised in that it comprises an arm fitted to rotate at the end of said dummy underframe, said arm is provided with hooking means able to coact with gripping means located in lower part of said container, said arm being able to bring said container from a position roughly on the ground to a ready-to-operate position of sliding trolley.

This device also has the advantage of allowing the loading and unloading of containers under a limited height ceiling as the maximum angle formed between the dummy underframe and the pivoting chassis is advantageously 15° in the loading position.

According to one embodiment, said arm is able to extend lengthwise.

According to another embodiment, said arm has horizontal rotary movement.

The last two embodiments described are intended to bring said hooking means to the level of said gripping means of the said container, without the operator having to execute many manoeuvres with the carrier vehicle.

Other goals and advantages will appear during the description which follows of a preferred embodiment which however is not restrictive.

It has to be remembered that the invention concerns a loading and unloading device for a vehicle comprising:
a container provided in its lower part with gripping means,
a dummy underframe on the vehicle,
a pivoting chassis fitted to tilt on said dummy underframe,
a trolley sliding on said pivoting chassis, able to bring said container onto said pivoting chassis through the action of drive means able to act with said gripping means of the said container,
   characterised in that it comprises an arm fitted to rotate at the end of said dummy underframe, said arm is provided with hooking means able to coact with gripping means located in lower part of said container, said arm being able to bring said container from a position roughly on the ground to a ready-to-operate position of sliding trolley.

According to preferred alternatives of the invention, said device is such that:
said arm can extend lengthwise to bring said hooking means to the level of said gripping means of said container,
said arm has a horizontal rotary movement designed to bring said hooking means to said gripping means of said container,
said arm is controlled by a hydraulic cylinder fixed at one end to dummy underframe and at the other end to said articulated arm.
said articulated arm is L-shaped and comprises: a long arm with said hooking means and a short arm
said pivoting chassis in the raised position forms with said dummy underframe an angle of 15°.

According to other preferred but non-restrictive embodiments, said device is such that:
it comprises firstly tilting means able to tilt the pivoting chassis into the loading position
it comprises second tilting means able to tilt the pivoting chassis into a dumping position.
said first and second means comprise at least one double acting hydraulic cylinder whose rods are mobile in opposite directions at both ends of the hydraulic cylinder.

Another aim of the invention is a vehicle equipped with the device previously described.

The attached drawings are given as examples and are not restrictive. They show only one embodiment of the invention and will make it possible to understand it easily.

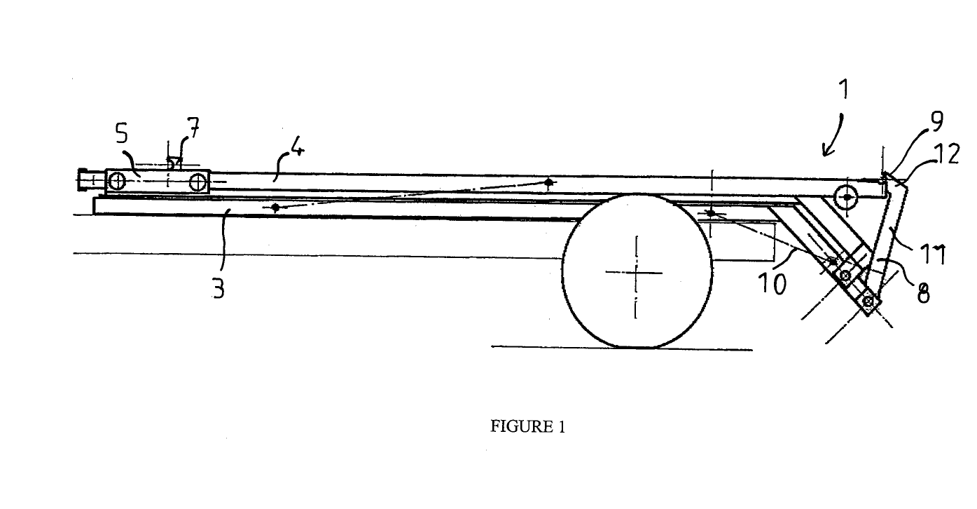

FIG. 1: view of the device in road position.

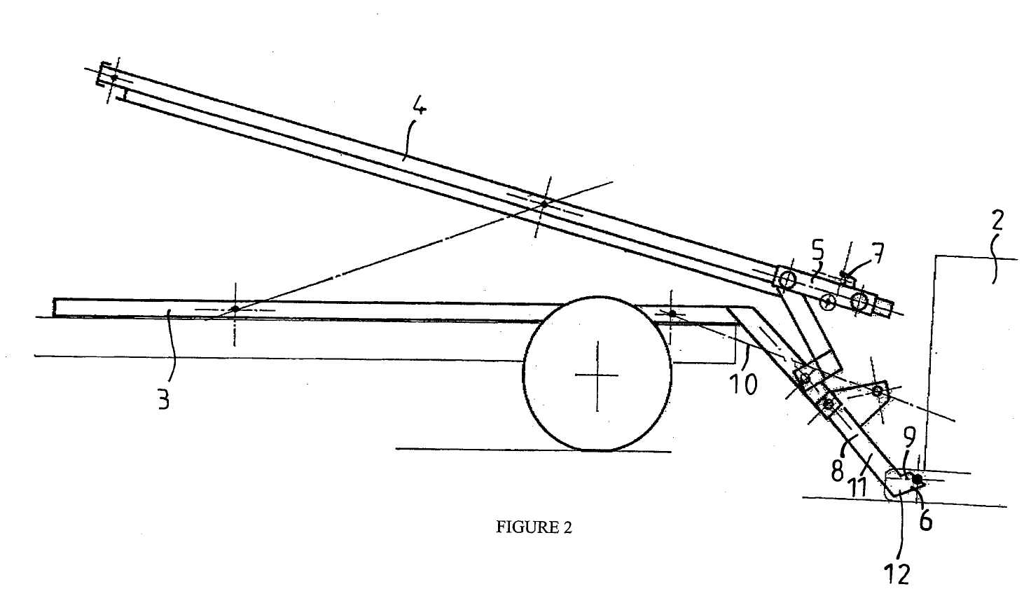

FIG. 2: view of the device in unfolded position for loading.

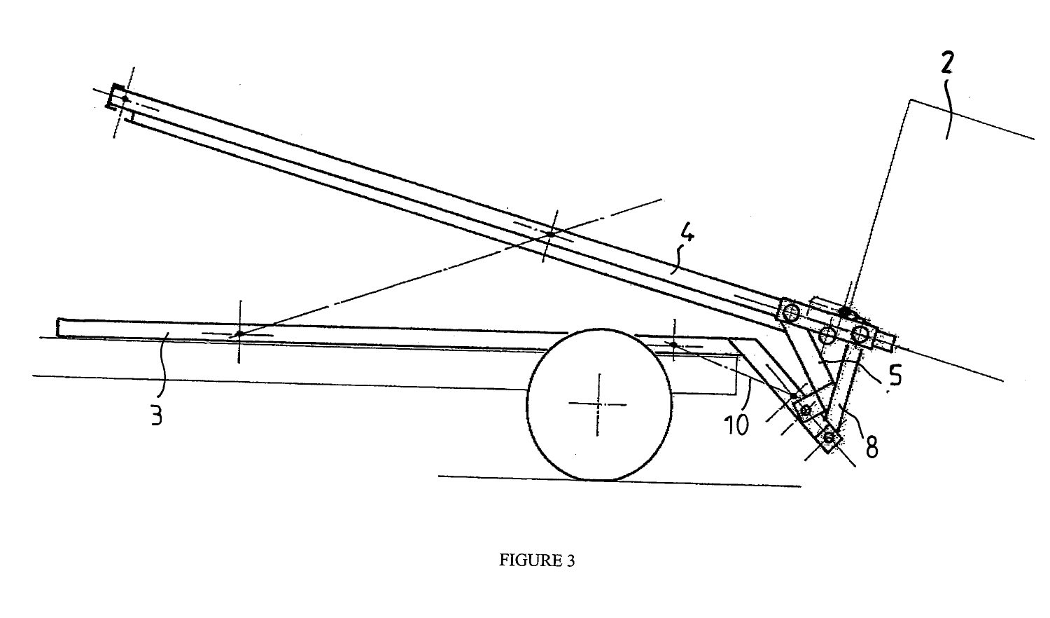

FIG. 3: view of the device in container transfer position of the sliding trolley arm.

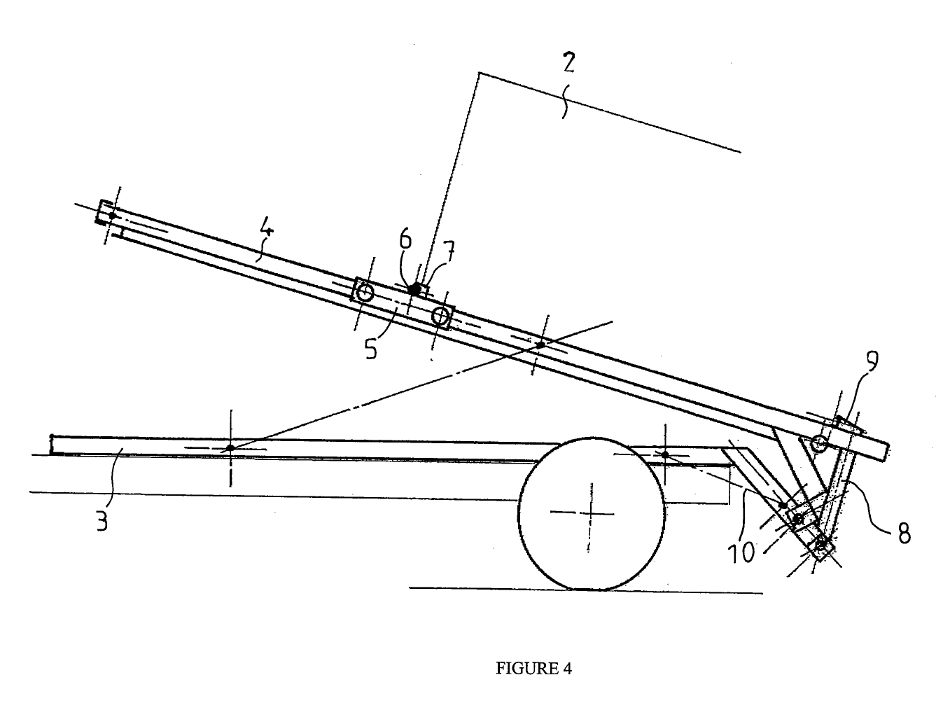

FIG. 4: view of the device in intermediate balanced position.

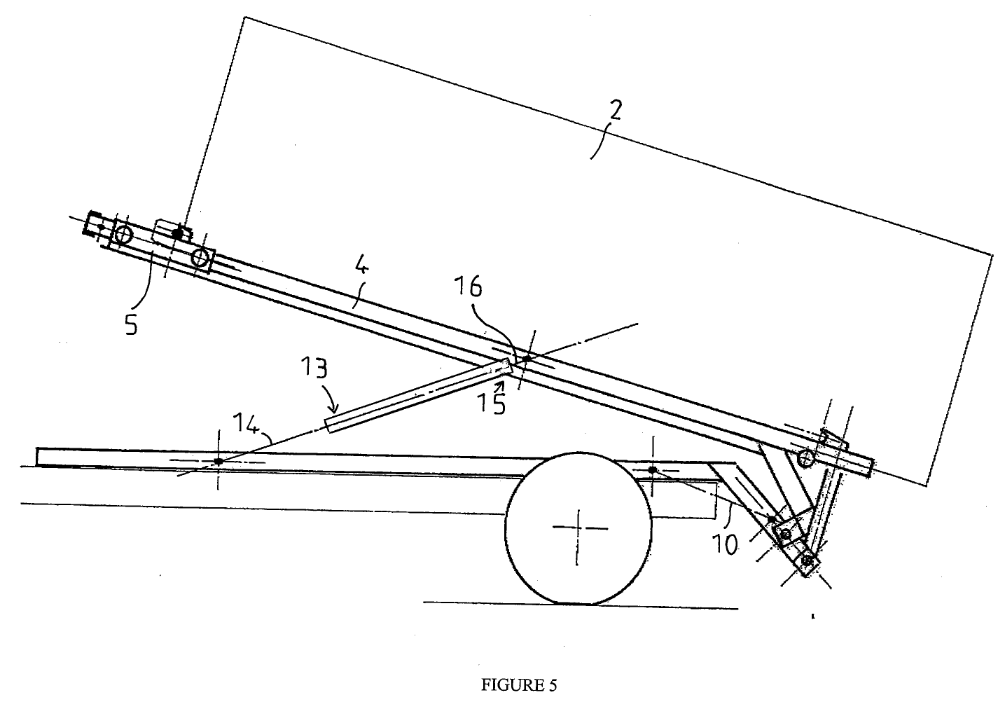

FIG. 5: view of the device in maximum position.

Device 1 for vehicle loading and unloading comprises:
a container (2) provided with gripping means (6) in the lower part,
a dummy underframe (3) mounted on or forming part of the original structure of the vehicle,
   the term dummy underframe being therefore any structure receiving the pivoting assembly,
a pivoting chassis (4) fitted to tilt on said dummy underframe (3),
a trolley (5) sliding on said pivoting chassis (4) able to bring said container (2) onto said pivoting chassis (4) by drive means (7) able to coact with said gripping means (6) of said container (2).

The assembly is in any usual material and can be a welded structure.

Said device (1) is characterised in that it has an arm (8) fitted to rotate on the end of said dummy underframe (3), said arm being provided with hooking means (9) able to bring with gripping means (6) located in the lower part of said container (2). Said arm (8) is able to bring said container (2) from a position substantially on the ground to a position of the sliding trolley ready-to-operate.

Advantageously, said arm (8) is able to extend lengthwise to bring said hooking means (9) to the level of said gripping means (6) of said container (2).

Gripping means (6) equip the container from the outset or are means mounted on a container so as to adapt it to the invention's intended use. It then consists of an interface for containers that are not equipped with hooking means in the lower part.

Advantageously, with the same aim, said arm (8) has horizontal rotary movement.

According to one embodiment, arm (8) is controlled by a hydraulic cylinder (10) fixed at one end to dummy underframe (4) and at the other end to arm (8).

Advantageously, said arm (8) is L-shaped comprising a long arm with said hooking means (9) and a short arm (12) acting as lever and on which is fixed controlling hydraulic cylinder (10).

The end of the arm consists of a hook gripping the container in the lower part, and making the sliding trolley available in the upper part.

### Example of Use:

When an operator wishes to move a container (2), he will bring a vehicle equipped with loading and unloading device (1) close to said container (2).

The vehicle in question may be of any type such as carrier, trailer, etc . . . It may or may not have its own motor.

At this stage, said device (1) is in the road configuration, that is to say the pivoting chassis (4) is folded back on the dummy underframe (3) substantially horizontal relative to the carrier vehicle chassis, arm (8) is folded, hooking means (9) being positioned at the level of dummy underframe (3).

Once the vehicle is positioned near container (2), the operator actuates pivoting chassis (4) which tilts relative to dummy underframe (3).

This tilting motion can be obtained by various means known in the prior art such as gas, oil or other types of cylinders.

Trolley (5) slides in the lower part of pivoting chassis (4) by means known in the prior art such as chains with crank, hydraulic cylinders, rollers, worm screw, cable, rack and pinion or other system.

Lastly, arm (8) unfolds under the action, advantageously, of a hydraulic cylinder (10) fixed at one end to the dummy underframe (3) and at other end to arm (8) at the level of short arm (12). Hooking means (9) are found roughly on the ground.

The operator can then adjust the position of hooking means (9) relative to gripping means (6) of said container (2), by controlling the length of arm (8) and its horizontal position.

Once hooking means (9) are positioned at the level of gripping means (6) of said container (2) (in the lower part), the user actuates arm (8) which performs a vertical rotary movement to bring container (2) roughly to the level of sliding trolley (5).

Trolley (5), provided with drive means (7) ready to coact with gripping means (6) of said container (2), will bring said container (2) onto pivoting chassis (4).

Pivoting chassis (4) gradually returns to a roughly horizontal position as said container (2) moves forward onto pivoting chassis (4).

Or according to another embodiment, pivoting chassis (4) returns to a roughly horizontal position once said container (2) is placed entirely on said pivoting chassis (4).

Arm (8) remains in folded position.

For unloading, the operations are performed in the reverse order.

It is advantageous to limit the tilting angle of frame (4) during loading, in particular to 15°, so as to only generate limited elevation during this phase. In particular, this helps with loading operations in buildings with limited clearances and not just in open areas.

For dumping operations, a greater angle of tilt is preferable. To achieve this, the device has two series of tilting means only one of which is activated on loading whereas the two series are activated on dumping so as to add their tilting effect to the pivoting frame (4).

The illustrated assembly shows a possible embodiment on FIG. 5 with a double acting hydraulic cylinder. This double acting hydraulic cylinder forms a first hydraulic cylinder (13) that is adequate for loading (the travel of its rod (14) allowing it to reach an angle of less than 15°).

The double acting hydraulic cylinder also constitutes a second hydraulic cylinder (15) whose rod (16) can be deployed in the same direction as rod (14) but in an opposite direction so that the deployments of the two rods cumulate to generate more ample tilting of frame (4).

One of the rods, for example rod (14), is articulated on dummy underframe (3). The other rod, that may be rod (16), is articulated on pivoting chassis (4).

### REFERENCES

1. Device
2. Container
3. Dummy underframe
4. Pivoting chassis
5. Trolley
6. Gripping means
7. Drive means
8. Arm
9. Hooking means
10. Hydraulic cylinder
11. Long arm
12. Short arm
13. Loading hydraulic cylinder
14. Rod
15. Dumping hydraulic cylinder
16. Rod

1. Device (1) for vehicle loading and unloading comprising:
a container (2) provided in its lower part with gripping means (6),
a dummy underframe (3) on the vehicle (13),
a pivoting chassis (4) fitted to tilt on said dummy underframe (3),
a trolley (5) sliding on said pivoting chassis (4), able to bring said container (2) on said pivoting chassis (4) by drive means (7) able to act with said gripping means (6) of said container (2),
characterised in that it comprises an arm (8) fitted to rotate at the end of said dummy underframe (3), said arm (8) is provided with hooking means (9) able to coact with gripping means (6) located in lower part of said container (2), said arm (8) being able to bring said container (2) from a position roughly on the ground to a ready-to-operate position of sliding trolley (5).

2. Device (1) according to claim 1 characterised in that said arm (8) can extend lengthwise to bring said hooking means (9) to the level of said gripping means (6) of said container (2).

3. Device (1) according to claim 1 characterised in that said arm (8) has a horizontal rotary movement designed to bring said hooking means (9) to said gripping means (6) of said container (2).

4. Device (1) according to claim 1 characterised in that said arm (8) is controlled by a hydraulic cylinder (10) fixed at one end to dummy underframe (3) and at the other end to said articulated arm (8).

5. Device (1) according to claim 1 characterised in that said articulated arm (8) is L-shaped and comprises: a long arm (11) with said hooking means (9) and a short arm (12).

6. Device (1) according to claim 1 characterised in that said pivoting chassis (4) in the raised position forms with said dummy underframe (3) an angle of 15°.

7. Device (1) according to claim 1 comprising firstly tilting means able to tilt the pivoting chassis (4) into the loading position.

8. Device (1) according to claim 7 comprising second tilting means able to tilt the pivoting chassis (4) into a dumping position.

9. Device (1) according to claim 8 in which said first and second means comprise at least one double acting hydraulic cylinder (13, 15) whose rods (14, 16) are mobile in opposite directions at both ends of the hydraulic cylinder.

10. Vehicle (13) equipped with device (1) according to claim 1.

11. Device (1) according to claim 2 characterised in that said arm (8) has a horizontal rotary movement designed to bring said hooking means (9) to said gripping means (6) of said container (2).

12. Device (1) according to claim 2 characterised in that said arm (8) is controlled by a hydraulic cylinder (10) fixed at one end to dummy underframe (3) and at the other end to said articulated arm (8).

13. Device (1) according to claim 3 characterised in that said arm (8) is controlled by a hydraulic cylinder (10) fixed at one end to dummy underframe (3) and at the other end to said articulated arm (8).

14. Device (1) according to claim 2 characterised in that said articulated arm (8) is L-shaped and comprises: a long arm (11) with said hooking means (9) and a short arm (12).

15. Device (1) according to claim 3 characterised in that said articulated arm (8) is L-shaped and comprises: a long arm (11) with said hooking means (9) and a short arm (12).

16. Device (1) according to claim 4 characterised in that said articulated arm (8) is L-shaped and comprises: a long arm (11) with said hooking means (9) and a short arm (12).

17. Device (1) according to claim 2 characterised in that said pivoting chassis (4) in the raised position forms with said dummy underframe (3) an angle of 15°.

18. Device (1) according to claim 3 characterised in that said pivoting chassis (4) in the raised position forms with said dummy underframe (3) an angle of 15°.

19. Device (1) according to claim 4 characterised in that said pivoting chassis (4) in the raised position forms with said dummy underframe (3) an angle of 15°.

20. Device (1) according to claim 5 characterised in that said pivoting chassis (4) in the raised position forms with said dummy underframe (3) an angle of 15°.
